(19) United States
(12) Patent Application Publication
(10) Pub. No.: US 2008/0294633 A1
(43) Pub. Date: Nov. 27, 2008

(54) COMPUTER-IMPLEMENTED METHOD, SYSTEM, AND PROGRAM PRODUCT FOR TRACKING CONTENT

(76) Inventors: John R. Kender, Leonia, NJ (US); Milind R. Naphade, Fishkill, NY (US)

Correspondence Address: HOFFMAN WARNICK LLC, 75 State Street, 14th Floor, ALBANY, NY, 12207, US

(21) Appl. No.: 12/169,127

(22) Filed: Jul. 8, 2008

Related U.S. Application Data
(63) Continuation of application No. 11/154,752, filed on Jun. 16, 2005.

(51) Int. Cl. G06F 7/06; G06F 17/30

(52) U.S. Cl. 707/5; 707/E17.014

(57) ABSTRACT

A system, method, and program product for tracking content are described. Aspects of invention allow bodies of content, whether from a common channel or from different channels, to be compared for relatedness. Comparison of different bodies of content involves analyzing both the actual content, characteristics of the source(s) of the content, and optionally, elapsed time between their respective broadcasts/communications. To this extent, a content similarity value, a source characteristic value and an optional temporal value for the portions of content are determined, and then used to compute a relatedness value of the (bodies of) content.

### CROSS-REFERENCE TO RELATED APPLICATIONS

This application is a continuation of application Ser. No. 11/154,752, filed Jun. 16, 2005. This application is also related in some aspects to the commonly assigned application entitled “Computer-Implemented Method, System, and Program Product For Evaluating Annotations to Content” that was filed on (will be provided), and is assigned attorney docket number YOR920050196US1 and serial number (will be provided), the entire contents of which are hereby incorporated by reference. This application is also related in some aspects to the commonly assigned application entitled “Computer-Implemented Method, System, and Program Product For Developing a Content Annotation Lexicon” that was filed on (will be provided), and is assigned attorney docket number YOR920050250US1 and serial number (will be provided), the entire contents of which are hereby incorporated by reference.

### STATEMENT OF GOVERNMENT RIGHTS

This invention was made with Government support under Contract 2004H839800 000 awarded by (will be provided). The Government has certain rights in this invention.

### BACKGROUND OF THE INVENTION

1. Field of the Invention

In general, the present invention provides a computer-implemented method, system and program product for tracking content (e.g., television programming, radio programming, Internet content, electronic mail, etc.). Specifically, the present invention determines a relatedness of two bodies of content based on an analysis of the actual content, characteristics of the source(s) of the content, and optionally, time passing (e.g., elapsed time) between their respective broadcasts.

2. Related Art

In recent years, the growing pervasiveness of media channels (e.g., television, radio, Internet, etc.) has lead to a desire to track the content being delivered. For example, it could be desirous to determine whether two video news broadcasts cover the same events. Unfortunately, making such a determination is challenging, particularly since news broadcasts by definition present material that is new and unexpected. There are typically two scenarios in which content tracking can be applied, namely, same channel and cross-channel. Same channel tracking is where multiple bodies of content delivered by a common channel (e.g., a specific television channel) are tracked/compared for similarity. Cross-channel is where multiple bodies of content delivered by different channels (e.g., two different television channels) are tracked/compared for similarity.

Existing methods for tracking same channel content are typically based on heuristic methods and empirical refinements thereof. For example, one methodology experiments with utilizing an empirical time separation value in an effort to better cluster together textual news broadcasts. This approach, however, has several drawbacks. For example, this approach fails to present any statistical derivation or postulate any differences for differing content sources. Further, it is unclear in this approach whether what happens in a textual corpora (e.g., where content comparison is based upon words) also occurs in the video corpora (e.g., where content comparison is based on visual concepts).

Cross-channel content tracking can be further complicated for additional reasons. For example, different channels might not only focus on delivering different types of content (e.g., sports news versus financial news), but different channels might have different policies for content life cycle. Moreover, cross-channel content tracking can involve tracking content from different media types (e.g., radio versus television). Irrespective of such differences, it could still be the case that two bodies of content delivered by different channels are related. For example, a news story about an athlete facing criminal charges is likely to be carried on both sports and news channels. As such, cross-channel tracking is a needed tool. Unfortunately, there is currently no approach for providing cross-channel content tracking.

In view of the foregoing, there exists a need for a method, system and program product for tracking content. Specifically, a system is needed that allows content to be tracked both within the same channel as well as cross-channel.

### SUMMARY OF THE INVENTION

In general, the present invention provides a method, system, and program product for tracking content. Specifically, the present invention allows content, whether communicated from a common channel or from different channels, to be compared for relatedness. The comparison of two bodies or “works” of content under the present invention involves an analysis of both the actual content, and one or more sources of the content. The comparison can also be based on time passing between the broadcasts/communications of the content. To this extent, a content similarity value for the bodies of content is determined. The content similarity value is based on: (1) a count of concepts that appear in both bodies of content; (2) a count of concepts that appear in the first body of content but not the second; (3) and a count of concepts that appear in the second body of content but not the first.

A source characteristic value will also be determined. The source characteristic value can be any type of quantitative value that pertains to the source(s) of the content. For example, the source characteristic value can be based on a similarity of the type of source(s) of the bodies of content. In such a case, if the content source is the same for both bodies of content, a value of one could be assigned for the source characteristic value. If the content sources are not the same but related (e.g., two news television stations), a value slightly lower than one could be assigned. If the content sources are unrelated (e.g., a news television station and an auction television station), an even lower value could be assigned. Still yet, a temporal value for the comparison can also be determined. If utilized, the temporal value is typically determined based on a quantity of time (e.g., days) passing between the broadcast of the two bodies of content and a re-visitation value. In any event, using the content similarity value, the source characteristic value (and the temporal value if utilized), a relatedness value of the two bodies of content can be mathematically computed.

A first aspect of the present invention provides a computer-implemented method for tracking content, comprising: determining a content similarity value based on concepts appearing in a first content and a second content; determining a source characteristic value corresponding to at least one source of the first content and the second content; and computing a relatedness value between the first content and the second content using the content similarity value and the source characteristic value.

A second aspect of the present invention provides a system for tracking content, comprising: a content similarity value system for determining a content similarity value based on concepts appearing in a first content and a second content; a source characteristic value system for determining a source characteristic value corresponding to at least one source of the first content and the second content; and a computation system for computing a relatedness value between the first content and the second content using the content similarity value and the source characteristic value.

A third aspect of the present invention provides a program product stored on a computer-useable medium for tracking content, the computer-useable medium comprising program code for causing a computer system to perform the following steps: determining a content similarity value based on a count of concepts appearing in both a first content and a second content, a count of the concepts appearing in the first content but not the second content, and a count of the concepts appearing in the second content but not the first content; determining a source characteristic value corresponding to at least one source of the first content and the second content; and computing a relatedness value between the first content and the second content using the content similarity value and the source characteristic value.

A fourth aspect of the present invention provides a method for deploying an application for tracking content, comprising: providing a computer infrastructure being operable to: determine a content similarity value based on concepts appearing in a first content and a second content; determine a source characteristic value corresponding to at least one source of the first content and the second content; and compute a relatedness value between the first content and the second content using the content similarity value and the source characteristic value.

A fifth aspect of the present invention provides computer software embodied in a propagated signal for tracking content, the propagated signal comprising instructions for causing a computer system to perform the following: determine a content similarity value based on concepts appearing in a first content and a second content; determine a source characteristic value corresponding to at least one source of the first content and the second content; and compute a relatedness value between the first content and the second content using the content similarity value and the source characteristic value.

### BRIEF DESCRIPTION OF THE DRAWINGS

These and other features of this invention will be more readily understood from the following detailed description of the various aspects of the invention taken in conjunction with the accompanying drawings that depict various embodiments of the invention, in which:

FIG. 1 shows an illustrative system for tracking content according to the present invention.

FIG. 2 shows illustrative plots of (log) probability versus (log) time for two content sources.

FIG. 3 shows a functional diagram for tracking content communicated from a common content source according to the present invention.

FIG. 4 shows a functional diagram for computer similarity of bodies of content communicated from different content sources according to the present invention.

It is noted that the drawings of the invention are not to scale. The drawings are intended to depict only typical aspects of the invention, and therefore should not be considered as limiting the scope of the invention. In the drawings, like numbering represents like elements between the drawings.

### DETAILED DESCRIPTION OF THE INVENTION

For convenience purposes, the Detailed Description of the Invention will have the following sections:

I. Computerized Implementation

II. Same Channel Tracking

III. Cross-Channel Tracking

IV. Additional Implementations

### I. Computerized Implementation

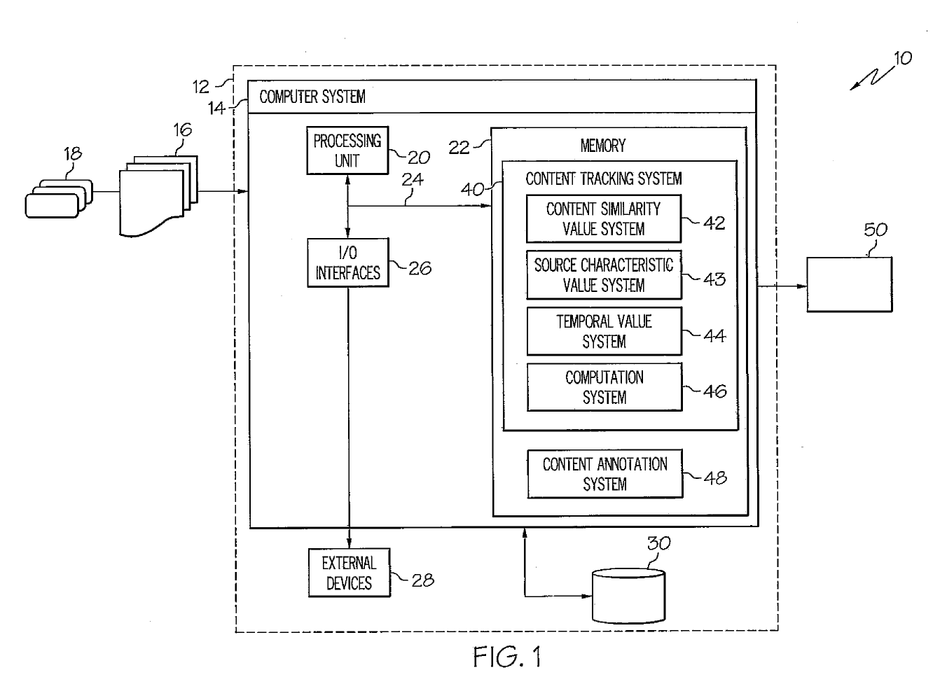

Referring now to FIG. 1, a system 10 for tracking content according to the present invention is shown. Specifically, FIG. 1 depicts a system 10 for determining a relatedness or similarity of multiple bodies/works of content 16 provided by (e.g., broadcast, communicated, etc.) or otherwise obtained from one or more content sources 18. It should be understood in advance that although in an illustrative example set forth below bodies of content 16 are news stories and content sources 18 are television stations, this need not be the case. That is, bodies of content 16 can be any type of content (e.g., video, radio, electronic mail, etc.) and content sources 18 can be any type of media channel (e.g., television station, radio station, electronic mail account, etc.). In addition, as will be further discussed below, system 10 provides a way to track multiple bodies of content 16 whether they originate from a single content source 18 (i.e., same channel tracking), or multiple content sources 18 (i.e., cross-channel tracking).

In any event, as depicted, system 10 includes a computer system 14 deployed within a computer infrastructure 12. This is intended to demonstrate, among other things, that the present invention could be implemented within a network environment (e.g., the Internet, a wide area network (WAN), a local area network (LAN), a virtual private network (VPN), etc., or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets-based protocol, and an Internet service provider could be used to establish connectivity to the Internet. Still yet, computer infrastructure 12 is intended to demonstrate that some or all of the components of system 10 could be deployed, managed, serviced, etc. by a service provider who offers to track content for customers.

As shown, computer system 14 includes a processing unit 20, a memory 22, a bus 24, and input/output (I/O) interfaces 26. Further, computer system 14 is shown in communication with external I/O devices/resources 28 and storage system 30. In general, processing unit 20 executes computer program code, such as content tracking system 40, which is stored in memory 22 and/or storage system 30. While executing computer program code, processing unit 20 can read and/or write data to/from memory 22, storage system 30, and/or I/O interfaces 26. Bus 24 provides a communication link between each of the components in computer system 14. External devices 28 can comprise any devices (e.g., keyboard, pointing device, display, etc.) that enable a user to interact with computer system 14 and/or any devices (e.g., network card, modem, etc.) that enable computer system 14 to communicate with one or more other computing devices.

Computer infrastructure 12 is only illustrative of various types of computer infrastructures for implementing the invention. For example, in one embodiment, computer infrastructure 12 comprises two or more computing devices (e.g., a server cluster) that communicate over a network to perform the various process steps of the invention. Moreover, computer system 14 is only representative of various possible computer systems that can include numerous combinations of hardware. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 20 may comprise a single processing unit, or be distributed across one or more processing units in one or more locations, e.g., on a client and server. Similarly, memory 22 and/or storage system 30 can comprise any combination of various types of data storage and/or transmission media that reside at one or more physical locations. Further, I/O interfaces 26 can comprise any system for exchanging information with one or more external devices 28. Still further, it is understood that one or more additional components (e.g., system software, math co-processing unit, etc.) not shown in FIG. 1 can be included in computer system 14. However, if computer system 14 comprises a handheld device or the like, it is understood that one or more external devices 28 (e.g., a display) and/or storage system(s) 30 could be contained within computer system 14, not externally as shown.

Storage system 30 can be any type of system (e.g., a database) capable of providing storage for information under the present invention, such as bodies of content 16, content similarity values, source characteristic values, temporal values, relatedness values, re-visitation values, algorithms for computing values, annotation lexicon(s), etc. To this extent, storage system 30 could include one or more storage devices, such as a magnetic disk drive or an optical disk drive. In another embodiment, storage system 30 includes data distributed across, for example, a local area network (LAN), wide area network (WAN) or a storage area network (SAN) (not shown). Although not shown, additional components, such as cache memory, communication systems, system software, etc., may be incorporated into computer system 14.

Shown in memory 22 of computer system 14 is a content tracking system 40 and content annotation system 48. As depicted, content tracking system 40 includes content similarity value system 42, a source characteristic value system 43, an optional temporal value system 44 and computation system 46. These systems will be described in further detail with respect to the specific scenarios of same channel tracking and cross-channel tracking set forth below.

### II. Same Channel Tracking

Under same channel tracking, multiple bodies of content 16 are received from a single content source 18. For the purposes of an example of same channel tracking, assume that a single television station is the source of two video news broadcasts (hereinafter referred to as broadcast “A” and broadcast “B”). In general, determining the relatedness of broadcasts “A” and “B” under the present invention is a function of content within the broadcasts themselves and the content source(s) 18 thereof. It can also be based on a temporal factor.

With respect to the temporal factor, the probability of a broadcast being related to a previous broadcast follows a power law. That is, if “gap” is the number of days that have elapsed from a prior broadcast of a story, then the likelihood of the occurrence of another broadcast of the same story is inversely proportional to gap raised to a power. For most purposes, including same channel tracking, the value of the power appears to be equal to one (i.e., the probability is inversely proportional to gap length). As will be further discussed in Section III below, this power law appears to hold when the bodies of content are provided by multiple content sources. Typically, content sources differ in how long their story broadcasts are, and how often they repeat them in a particular day, but the extended life cycle of news stories over at least two weeks and over at least two providers appears to be universal. Given this relatively steep statistical drop-off in broadcasting re-occurrence, effective matching and clustering of broadcasts can be done in a small temporal window, rather than over the entire corpus of broadcasts. This increases accuracy and decreases storage and processing time. Additionally, this statistical information lends itself to the formation of a streaming, on-line broadcast clustering method, one that only has to keep on hand a relatively small sample of the most recent past broadcasts.

Determining a relatedness of bodies of content such as broadcast “A” and broadcast “B” in accordance with the present invention can involve multiple factors. These factors can include, for example, a similarity of the actual content (e.g., a content similarity or Dice factor/value), the characteristics of the content source(s) 18, and optionally a timing between the broadcasts (e.g., a temporal factor/value). Specifically, under one embodiment of the present invention, the relatedness of broadcasts “A” and “B” is represented by the algorithm

(Dice(i,j)*S)*(Vb/(d+1))

where Dice(i,j) is a Dice metric borrowed from information retrieval in which “i” refers to broadcast “A” and “j” refers to broadcast “B”; S is a source characteristic value related to the source 18 of bodies of content 16; Vb is a following day re-visitation value for the content source of broadcast “B” (which, as will be further described below, is equal to one since both broadcasts “A” and “B” are from a common content source); and d is the amount of time (e.g., in days) between the showing of broadcasts “A” and “B”. Vb/(d+1) is referred to collectively as a temporal factor, which is an optional factor under the present invention.

More specifically, Dice(i,j) is the Dice metric borrowed from Information retrieval: each broadcast is considered to be a vector of binary presences or absences of visual concepts. To this extent, Dice(i,j) is a content similarity value between broadcasts “A” and “B” as determined by content similarity value system 42 of content tracking system 40. It should be understood that Dice is one of many content similarity computations that could be used under the present invention. Others include: “Jaccard”, “Simpson”, “Otsuka”, “Cosine”, etc. Regardless, to compute the content similarity value for broadcasts “A” and “B”, content similarity value system 42 can apply the following algorithm to determine Dice(i,j):

2a/(2a+b+c)

where a is a count of concepts appearing in both broadcasts “A” and “B”, b is a count of concepts present in broadcast “A” but not broadcast “B”, and c is a count of concepts appearing in broadcast “B” but not broadcast “A”. Fully matching bodies of content 16 will have a content similarity value of one. This value will decrease as bodies of content 16 become more dissimilar. Regardless, in determining these counts, content similarity value system 42 will analyze and count annotations or tags applied to broadcasts “A” and “B” manually by a human Ontologist, or automatically by content annotation system 48. In general, the annotations to broadcasts “A” and “B” are based on the underlying content thereof. For example, a news story about Muhammad Ali could have the annotations “boxing”, “Muhammad”, and/or “Ali”. Moreover, the annotations can be specific (like “Ali”) or general (like “human”, “moving”). What is a permitted annotation is determined by consistent rules, exercised either by the Ontologist or a computer program. The practice of annotation is known as Ontology and will not be discussed in significantly greater detail herein. However, human Ontologists and/or content annotation system 48 will annotate content using a lexicon of established terms or concepts. Shown below are illustrative terms/concepts with which content can be annotated:
Events: Person-Action (e.g., Monologue [News-Subject-Monologue], Sitting, Standing, Walking, Running, Addressing); People-Event (e.g., Parade, Picnic, Meeting); Sport-Event (Baseball, Basketball, Hockey, Ice-Skating, Swimming, Tennis, Football, Soccer); Transportation-Event (e.g., Car-Crash, Road-Traffic, Airplane-Takeoff, Airplane-Landing, Space-Vehicle-Launch, Missile-Launch); Cartoon; Weather-News; Physical-Violence (e.g., Explosion, Riot, Fight, Gun-Shot).
Scenes: Indoors (e.g., Studio-Setting, Non-Studio-Setting [House-Setting, Classroom-Setting, Factory-Setting, Laboratory-Setting, Meeting-Room-Setting, Briefing-Room-Setting, Office-Setting, Store-Setting, Transportation-Setting]); Outdoors (e.g., Nature-Vegetation [Flower, Tree, Forest, Greenery], Nature-NonVegetation [Sky, Cloud, Water-Body, Snow, Beach, Desert, Land, Mountain, Rock, Waterfall, Fire, Smoke], Man-Made-Scene [Bridge, Building, Cityscape, Road, Statue]); Outer-Space; Sound (e.g., Music, Animal-Noise, Vehicle-Noise, Cheering, Clapping, Laughter, Singing).
Objects: Animal (e.g., Chicken, Cow); Audio (e.g., Male-Speech, Female-Speech); Human (e.g., Face [Male-Face: Bill-Clinton, Newt-Gingrich, Male-News-Person, Male-News-Subject], [Female-Face: Madeleine-Albright, Female-News-Person, Female-News-Subject], Man-Made-Object (e.g., Clock, Chair, Desk, Telephone, Flag, Newspaper, Blackboard, Monitor, Whiteboard, Microphone, Podium); Food; Transportation (e.g., Airplane, Bicycle, Boat, Car, Tractor, Train, Truck, Bus); Graphics-And-Text (e.g., Text-Overlay, Scene-Text, Graphics, Painting, Photographs).
It should be understood that content annotation system 48, if used, is programmed to analyze content to recognize concepts, and to annotate the content based on the recognized concepts using an applicable lexicon (e.g., as stored in storage system 30). It can further be programmed with other logic applicable to annotation, concept clustering, collocation, and/or information gain. For example, for each pair of concepts, X and Y, content annotation system 48 and/or a human Ontologist could form a two-by-two contingency table for the occurrence of X and Y within the same “shot”, and then compute H(table)-H(rows)-H(columns), where H(.) is an entropy function. In this case, extreme values could signal collocations. For “avoidant” concepts, point-wise mutual information, I(X; Y)=H(X)−H(X|Y) could be used. If this value is negative, it indicates that knowing that concept X appears within a “shot” decreases the likelihood that Y also appears. In addition, information gain for each concept could be defined under the present invention by the binarization Gain(S,C)=H(S)−(|Sp|/|S|)H(Sp)−(|Sn|/|S|)H(Sn), where S is the story, C is the concept, H(.) is entropy, and Sp is the subset of episodes positively having the concept C, with Sn defined analogously.

In any event, assume that broadcast “A” is annotated with “dog” and “cat” and broadcast “B” is annotated with “cat” and “mouse”. In such a case, a (i.e., the count of concepts appearing in both broadcasts is equal to 1; b (i.e., the count of concepts appearing in “A” but not in “B”) is equal to 1; and c (i.e., the count of concepts appearing in “B” but not in “A”) is also equal to 1. As such, the content similarity value (i.e., the Dice metric) will be computed by content similarity value system 42 as follows:

2/(2+1+1)= 2/4=½

As indicated above, the present invention computes similarity of bodies of content 16 such as broadcasts “A” and “B” based on an analysis of the actual content (e.g., as quantified by the content similarity value) as well as on an analysis of source characteristics and, optionally, time passing between the broadcasts. To this extent, source characteristic value system 43 will determine a source characteristic value for content source 18. In general, the source characteristic value can be based on any type of standard. For example, if the source of two bodies of content is the same, a value of one could be assigned. If the sources are different (i.e., cross-channel), a value of less than one could be assigned. Since broadcasts “A” and “B” are both from the same content source 18, assume in this example that the source characteristic value is 1.0.

If utilized, temporal value system 44 will determine a temporal value for the computation. In general, the temporal value is defined by Vb/(d+1) where Vb is a re-visitation value of the source of the second content (e.g., broadcast “B”) and d is a number of days passing between broadcasts “A” and “B”. It is noted under the present invention that similarity between content tends to follow a power law represented by

Pr(Same(i,j))=Vb(d+1)^{k}

Where V_{b} is determinable by a statistical study of the source, whereby the more time that elapses between broadcasting of bodies of content, the less likely they are to be related. For example, for a news story, tracking, k=(−1) such that the fading is inversely proportional to (d+1). This implies that 70% of the time, a story repeats in zero, one or two days.

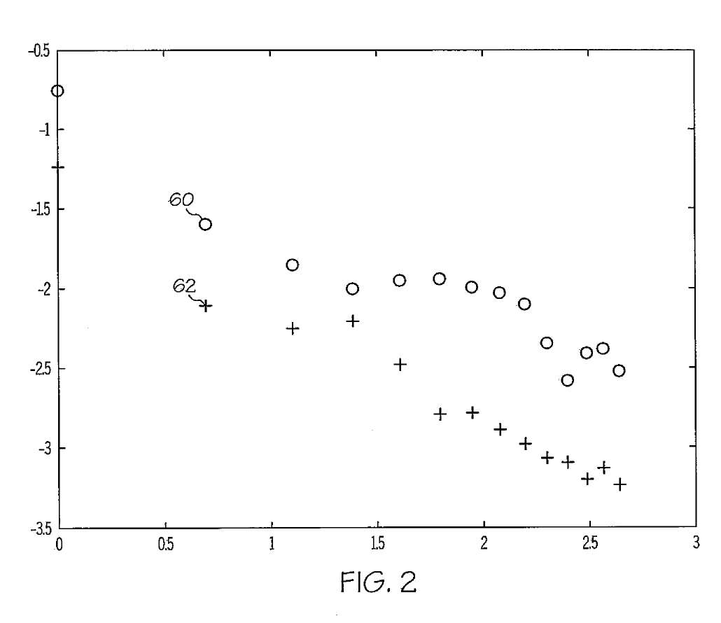

Referring briefly to FIG. 2, this concept is illustrated in greater detail for two content sources. Specifically, FIG. 2 depicts two plots 60 and 62 of the log of the probability that bodies of content from a particular content source will be related versus the log of the time elapsed. That is, plot 60 depicts the probability that stories from content source “1” will be related to one another as time between their respective broadcasts passes, while plot 62 depicts the probability that stories from content source “2” will be related to one another as time between their broadcasts increases. As can be seen, a similar pattern is established for both content sources. That is, as time increases, there is less chance that two stories from a single content source will be related.

Referring back to FIG. 1, for same channel tracking, Vb most closely resembles a value of one. Thus, the temporal value for the same channel tracking embodiment is determined based on the algorithm:

1/(d+1)

This indicates that bodies of content 16 appearing on the same day are accorded their full Dice probability or content similarity value, bodies of content 16 a day apart have their Dice probability halved, etc. For improved performance, the method of information gain is used to prune low information concepts from the binary concept vector; sometimes this pruning reduces the vector lengths by as much as a factor of 70.

Given this full similarity metric between broadcasts “A” and “B”, the present invention can use known methods to solve a generalized eigenvalue issue of (D−S)v=lambda*Dv. Here, S is the similarity matrix of all bodies of content compared with each other, and D is the diagonal Laplacian matrix whose entries D(i,j) are each given by the sum of row i in S. This results in a low dimensional manifold that optimally separates story classes. In one example, the first dimension of this manifold roughly corresponds to a dimension along which video broadcasts about one topic (e.g., the President) are contrasted to video broadcasts regarding other topics (e.g., sports).

Assume now in this example, that the amount of time passing between broadcasts “A” and “B” is two days. As such d=2 and the temporal value is determined by temporal value system 44 as follows:

1/(2+1)=⅓

Once the temporal value is computed, computation system 46 will mathematically determine/compute a relatedness value 50 between broadcasts “A” and “B”. Under one embodiment of the present invention, the relatedness value 50 is computed by multiplying the content similarity (or Dice) value by the source characteristic value, and if used, further by the temporal value. If only the source characteristic value and the content similarity value are utilized, relatedness value 50 would be yielded by computation system 46 as follows:

(½)*(1)=½ or 0.5

If all three values are utilized, relatedness value 50 would be yielded as follows:

(½)*(1)*(⅓)=⅙ or 0.166

It should be understood any algorithm for computing the relatedness factor could be utilized under the present invention. For example, the content similarity value, the source characteristic value, and/or the temporal value could be raised to a power before being multiplied; values could be divided into each other, etc. Once computed, relatedness value 50 can be compared to a predetermined scale, graph or the like of relatedness values to more fully understand the relatedness of broadcasts “A” and “B”.

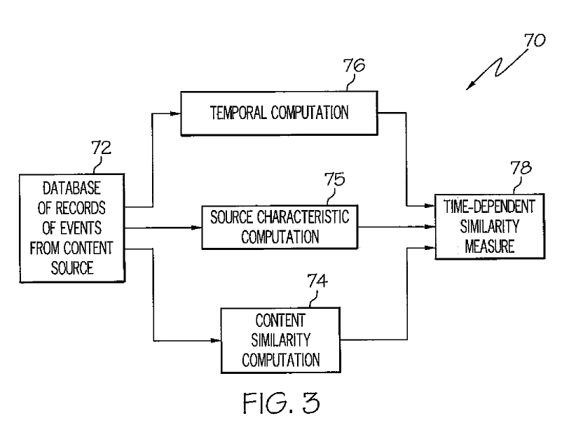

Referring to FIG. 3, a functional diagram 70 of same channel tracking utilizing all three values according to the present invention is shown. Specifically, FIG. 3 depicts the scenario where a relatedness is determined between two bodies of content (e.g., broadcasts “A” and “B”) from a single content source. As shown, using data from the single content source (e.g., a database of records of events 72), the present invention will compute a content similarity value in block 74, a source characteristic value in block 75, and an optional temporal value in block 76. This data can include metadata corresponding to annotations made to the bodies of content, temporal metadata, etc. These values will then be used to determine a similarity measure in block 78, which is shown in FIG. 1 as relatedness value 50. It should be understood that the depiction of the temporal value block 76 is optional and is shown in FIG. 3 for illustrative purposes only.

### III. Cross-Channel Tracking

Referring back to FIG. 1, the tracking of content in a cross-channel embodiment of the present invention will be discussed. Specifically, in this embodiment, assume that broadcasts “A” and “B” are made by two different content sources, namely, content source “1” and content source “2”, respectively.

Empirical investigation of a large number of annotated video broadcasts of news stories from two separate channels (e.g., CNN and ABC) indicates that two content sources can differ in their approaches to broadcast creation and presentation. By formalizing and examining this creation process, it is apparent that cross-channel matching should normalize broadcasts/episodes for length and for repetition rates. The general conclusion is that standard Information Retrieval methods should be adapted to this domain. To normalize for systematically differing broadcast lengths, each broadcast is best represented by a binary-valued vector of concept presence, rather than an integer-valued vector of concept occurrences. To normalize for systematically differing broadcast temporal spacing, each broadcast is best represented by its date of presentation rather than a more precise time stamp. Under this normalization, story “life cycle” statistics between channels become similar, with the probability of a broadcast recurring becoming inversely proportional to the number of days elapsing since the prior broadcast. By finding a way in which cross-channel differences are minimized, all bodies of content (e.g., video news broadcasts) can be considered to have originated from a single channel. Similarity/relatedness comparisons across channels are therefore more accurate, allowing all broadcasts of a video story to be clustered together, regardless of source.

Under the present invention, there can be several significant aspects of the formation of bodies of content 16 that impact their tracking over time and across channels. In keeping with the illustrative example set forth herein, these aspects are discussed below in conjunction with video news broadcasts as presented by two specific television stations (e.g., CNN and ABC). It should be understood, however, they can be applied to any media channel (e.g., television station, radio station, electronic mailing account, etc.) and/or any content type (audio, video, electronic mail, etc.).

(A) The actual selection of video stories for presentation on a given day differs significantly by station. For example, there is only a moderate correlation between stories chosen on a day by ABC compared to those chosen by CNN. Although the long-term emphasis given by the two stations to a given newsworthy story appears similar, it is not so similar as to enable same-day predictions.

(B) Stations differ significantly in their within-day repetition rates. For example, CNN repeats broadcasts much more frequently on the same day, compared to ABC. This repetition rate has been quantified: same-day repetition in CNN occurs with a probability of 0.40; in ABC with a probability of 0.28.

(C) Stations differ in their distributions of broadcast lengths. ABC broadcasts follow a trimodal distribution: many broadcasts are under one minute, some are between one and four minutes, the rest are considerably longer. In contrast, CNN has very few long broadcasts, and its distribution is therefore bimodal, but it has different means and standard deviations from ABC for its own two temporal modes.

(D) In contrast, stations do appear to have identical policies with respect to the fading life cycle of video broadcasts, following a distribution describable as “blue noise”. This may be related to the similarity of judgment of news editors as to when a story is “no longer news”. As indicated for same channel tracking in Section II above, approximately 70% of the time the next broadcast of a story occurs within two days. More specifically, the statistics support that the probability that another broadcast of a story will re-occur after a gap of days can be computed as being inversely proportional to the length of the gap, plus 1.

To compute relatedness value 50 for two bodies of content from two different content sources, a methodology similar to same channel tracking will be employed under the present invention. That is, the relatedness factor will be defined by the following algorithm:

(Dice(i,j)*S)*(Vb/(d+1))

where Dice(i,j) is the content similarity value computed by content similarity value system 42. As indicated above, Dice(i,j) can be represented by the algorithm:

2a/(2a+b+c)

where a is a count of concepts appearing the both broadcasts “A” and “B”, b is a count of concepts present in broadcast “A” but not broadcast “B”, and c is a count of concepts appearing in broadcast “B” but not broadcast “A”. As indicated above, these counts are determined based on annotations made to broadcasts “A” and “B” by a human Ontologist and/or content annotation system 48. Regardless, assume once again that a=b=c=1. In this case, the content similarity value (i.e., the Dice metric) will be computed by content similarity value system 42 as follows:

2/(2+1+1)= 2/4=½

Just as with same channel tracking, the relatedness of the two broadcasts depends not only on the content similarity value, but on a source characteristic value defined by “S” as determined by source characteristic value system 43. This value will be different than it is for bodies of content 16 provided from a common content source 18. It can also be based on a type of content sources 18 (or a similarity thereof). For example if both content source “1” and content source “2” are television news stations, the value can be lower than one, but higher than it would be if the content sources were in different fields of endeavor. In an illustrative example, assume that the source characteristic value is ⅘ or 0.8 (e.g., assume that both content sources are television news stations).

In any event, the cross-channel embodiment can also (optionally) involve the determination of a temporal value by temporal value system 44. As shown above, the temporal value is defined by:

Vb/(d+1)

Similar to same channel tracking, this tends to follow an inverse power law for cross-channel tracking. However, with cross-channel tracking, the Vb value will be less than one. In a typical embodiment, Vb is received from the second content source or is determined by temporal value system 44 based on data (or meta data) provided by the second content source. Assuming in this example that the Vb for content source “2” is ½ or 0.5, and that the amount of time passing between broadcasts “A” and “B” is two days, the temporal value would be determined by temporal value system 44 as follows:

(½)/(2+1)=(½)/3=⅙=0.166

Once the content similarity value, the source characteristic value and (optionally) the temporal value have been determined, computation system 46 will mathematically determine/compute relatedness value 50 between broadcasts “A” and “B”.

As mentioned above, one embodiment of the present invention computes relatedness value 50 by multiplying the content similarity (or Dice) value by the source characteristic value, and optionally, the temporal value. If only the content similarity value and the source characteristic value are used, relatedness value 50 would be yielded by computation system 46 as follows:

(½)*(⅘)=⅖=0.4

If the temporal value is also included, relatedness value 50 would be yielded by computation system 46 as follows:

(½)*(⅘)*(⅙)= 1/15=0.066

Similar to same channel tracking, it should be understood that any algorithm for computing the relatedness factor could be utilized under the present invention. For example, the content similarity value, source characteristic value, and/or the temporal value could be raised to a power before being multiplied; values could be divided into each other, etc. Regardless, once computed, relatedness value 50 can be compared to a predetermined scale, graph or the like of relatedness values to more fully understand the relatedness of broadcasts “A” and “B”. In comparing the relatedness value yielded by same channel tracking to the relatedness value yielded by cross-channel tracking, it can be seen that the relatedness value for cross-channel tracking is less than same channel tracking. This is generally indicative that two bodies of content 16 from two different content sources 18 (e.g., ABC and CNN) are less likely to be related to one another than two bodies of content 16 from the same content source (e.g., CNN) given the same time “gap” between broadcasts.

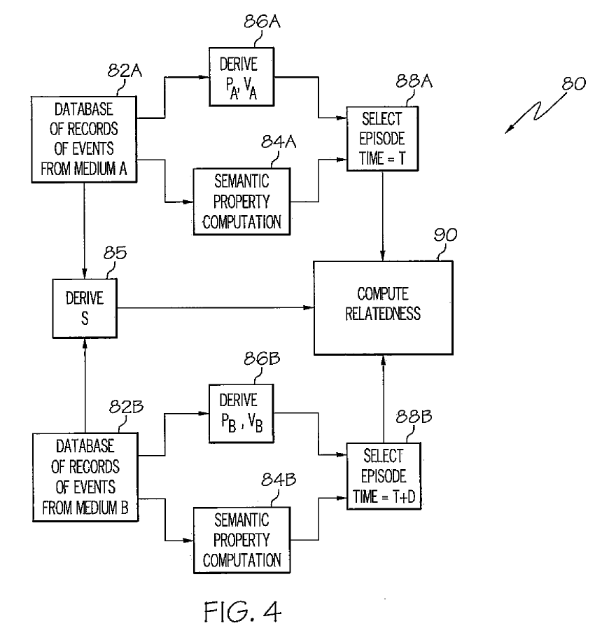

Referring now to FIG. 4, a functional diagram 80 of cross-channel tracking according to the present invention is shown. In blocks 84A-B, semantic properties are computed so that a content similarity factor can be determined. This generally involves using annotation metadata from the respective content sources databases of records of events 82A-B). Specifically, between blocks 84A-B, the count values for a, b and c will be determined and the Dice value will be computed. In block 85, the source characteristic value will be computed. In optional blocks 86A-B, the respective Va, Vb and Pa and Pb values will be computed. As shown in FIG. 2 above, the probability values Pa and Pb generally follow an inverse power law. In blocks 88A-B, the timing of each broadcast is determined so that a time gap “d” can be determined. Lastly, in block 90 the relatedness value is computed by weighting the content similarity (Dice) value by the source characteristic value, and optionally, by the temporal value Vb/(D+1).

It should be understood that for same channel tracking and cross-channel tracking, certain variations could be within the scope of keeping with the present invention. For example, the time gap in the illustrative examples set forth above was measured in days. However, this need not be the case. Rather, any quantifiable unit of time (e.g., seconds, minutes, minutes, weeks, etc.) could be utilized under the present invention.

### IV. Additional Implementations

While shown and described herein as a method and system for tracking content, it is understood that the invention further provides various alternative embodiments. For example, in one embodiment, the invention provides a computer-readable medium that includes computer program code to enable a computer infrastructure to automatically track content. To this extent, the computer-readable medium includes program code that implements each of the various process steps of the invention. It is understood that the term “computer-readable medium” comprises one or more of any type of physical embodiment of the program code. In particular, the computer-readable medium can comprise program code embodied on one or more portable storage articles of manufacture (e.g., a compact disc, a magnetic disk, a tape, etc.), on one or more data storage portions of a computing device, such as memory 22 (FIG. 1) and/or storage system 30 (FIG. 1) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process steps of the invention on a subscription, advertising, and/or fee basis. That is, a service provider, such as a Solution Integrator, could offer to track content. In this case, the service provider can create, maintain, support, etc., a computer infrastructure, such as computer infrastructure 12 (FIG. 1) that performs the process steps of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for tracking content. In this case, a computer infrastructure, such as computer infrastructure 12 (FIG. 1), can be provided and one or more systems for performing the process steps of the invention can be obtained (e.g., created, purchased, used, modified, etc.) and deployed to the computer infrastructure. To this extent, the deployment of a system can comprise one or more of (1) installing program code on a computing device, such as computer system 14 (FIG. 1), from a computer-readable medium; (2) adding one or more computing devices to the computer infrastructure; and (3) incorporating and/or modifying one or more existing systems of the computer infrastructure to enable the computer infrastructure to perform the process steps of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

1-20. (canceled)

21. A computer-implemented method for tracking content, comprising:
determining a content similarity value based on concepts appearing in a first content and a second content;
determining a source characteristic value corresponding to at least one source of the first content and the second content; and
computing a relatedness value between the first content and the second content using the content similarity value and the source characteristic value.

22. The computer-implemented method of claim 21, wherein the content similarity value is determined based on:
a count of the concepts appearing in both the first content and the second content;
a count of the concepts appearing in the first content but not the second content; and
a count of the concepts appearing in the second content but not the first content.

23. The computer-implemented method of claim 21, wherein the relatedness value is further computed based on a temporal value that is determined based on a re-visitation value and elapsed time between a communication of the first content and a communication of the second content.

24. The computer-implemented method of claim 23, wherein the first content and the second content are from a common content source, and wherein the re-visitation value is equal to a value of one.

25. The computer-implemented method of claim 23, wherein the first content is from a first content source and the second content is from a second content source, and wherein the re-visitation value is less than a value of one.

26. The computer-implemented method of claim 25, wherein the re-visitation value is obtained from the second content source.

27. The computer-implemented method of claim 21, wherein the relatedness value is determined by multiplying the source characteristic value by the content similarity value.

28. A system for tracking content, comprising:
a content similarity value system for determining a content similarity value based on concepts appearing in a first content and a second content;
a source characteristic value system for determining a source characteristic value corresponding to at least one source of the first content and the second content; and
a computation system for computing a relatedness value between the first content and the second content using the content similarity value and the source characteristic value.

29. The system of claim 28, wherein the content similarity value is determined based on:
a count of the concepts appearing in both the first content and the second content;
a count of the concepts appearing in the first content but not the second content; and
a count of the concepts appearing in the second content but not the first content.

30. The system of claim 28, wherein system further comprises a temporal value system for determining a temporal value based on a re-visitation value and an amount of time passing between a communication of the first content and a communication of the second content, and wherein the relatedness value is further computed based on the temporal value.

31. The system of claim 30, wherein the first content and the second content are from a common content source, and wherein the re-visitation value is equal to a value of one.

32. The system of claim 30, wherein the first content is from a first content source and the second content is from a second content source, and wherein the re-visitation value is less than a value of one.

33. The system of claim 32, wherein the re-visitation value is obtained from the second content source.

34. A program product stored on computer-useable medium for tracking content, the computer-useable medium comprising program code for causing a computer system to perform the following steps:
determining a content similarity value based on a count of concepts appearing in both a first content and a second content, a count of the concepts appearing in the first content but not the second content, and a count of the concepts appearing in the second content but not the first content;
determining a source characteristic value corresponding to at least one source of the first content and the second content; and
computing a relatedness value between the first content and the second content using the content similarity value and the source characteristic value.

35. The program product of claim 34, wherein the computer-useable medium further comprises program code to cause the computer system to determine a temporal value based on a re-visitation value and an amount of time passing between a communication of the first content and a communication of the second content, and wherein the relatedness value is further computed based on the temporal value.

36. The program product of claim 35, wherein the first content and the second content are from a common content source, and wherein the re-visitation value is equal to a value of one.

37. The program product of claim 35, wherein the first content is from a first content source and the second content is from a second content source, and wherein the re-visitation value is less than a value of one.

38. The program product of claim 37, wherein the re-visitation value is obtained from the second content source.

39. A method for deploying an application for tracking content, comprising:
providing a computer infrastructure being operable to:
determine a content similarity value based on concepts appearing in a first content and a second content;
determine a source characteristic value corresponding to at least one source of the first content and the second content; and
compute a relatedness value between the first content and the second content using the content similarity value and the source characteristic value.
